(19) United States
(12) Patent Application Publication
(10) Pub. No.: US 2016/0206139 A1
(43) Pub. Date: Jul. 21, 2016

(54) INDOOR GRILL APPLIANCE

(71) Applicant: General Electric Company, Schenectady, NY (US)

(72) Inventor: Eric Scott Johnson, Louisville, KY (US)

(21) Appl. No.: 14/597,270

(22) Filed: Jan. 15, 2015

(51) Int. Cl. A47J 37/06

(52) U.S. Cl. CPC A47J 37/06

(57) ABSTRACT

An indoor grill and oven appliance is provided including a cabinet defining an oven cooking chamber with one or more oven heating elements configured to heat the oven cooking chamber. Positioned above the oven cooking chamber, the indoor grill and oven appliance includes one or more grill heating elements and one or more grates. The one or more grates are in thermal communication with the one or more grill heating elements. A hood assembly is disposed above the one or more grates and defines a substantially enclosed grill cooking chamber with the cabinet to facilitate indoor grilling operations while reducing a risk of damaging and/or dirtying indoor walls and ceilings.

### FIELD OF THE INVENTION

The present subject matter relates generally to grill appliances, or more particularly to grill appliances suitable for conducting grilling operations indoors.

### BACKGROUND OF THE INVENTION

Grilling has long been a popular form of cooking. Typical grills generally include one or more heating elements disposed below a grilling surface. A top is removably positioned over the grilling surface, the top and the grilling surface together defining a grilling chamber. During grilling operations, cooking gases may be mostly trapped within the grilling chamber by the top. However, upon removal of the top, e.g., to examine food positioned on the grilling surface, to add or remove food to or from the grilling surface, or to reorient food positioned on the grilling surface, cooking gases are expelled to the atmosphere. The cooking gasses may include grease, smoke, or other fumes resulting from the grilling operations.

In order to avoid damage to, e.g., a ceiling of a kitchen, grills are operated outdoors or in other areas where the cooking gasses may be directly expelled from the cooking chamber to the atmosphere. However, in certain environments, outdoor grilling may not be convenient during all four seasons. For example, in certain environments, it may to too cold to comfortably grill outdoors during winter. Conversely, in certain environments, it may be too hot to comfortably grill outdoors during the summer. Additionally, other environmental conditions, such as rain, wind, snow, etc. may make it inconvenient to conduct grilling operations outdoors.

Accordingly, a grill suitable for indoor use would be useful. More specifically, a grill capable of containing unconditioned cooking gases during cooking operations would be especially beneficial.

### BRIEF DESCRIPTION OF THE INVENTION

Aspects and advantages of the invention will be set forth in part in the following description, or may be apparent from the description, or may be learned through practice of the invention.

In a first exemplary embodiment, an indoor grill and oven appliance is provided. The indoor grill and oven appliance defines a vertical direction and includes a cabinet defining an oven cooking chamber, one or more oven heating elements configured to heat the oven cooking chamber, and one or more grill heating elements. The one or more grill heating elements are disposed within the cabinet and positioned above the oven cooking chamber along the vertical direction. The indoor grill and oven appliance also includes one or more grates in thermal communication with the one or more grill heating elements and a hood assembly. The hood assembly is disposed above the one or more grates along the vertical direction and defines a substantially enclosed grill cooking chamber with the cabinet.

In a second exemplary embodiment, an indoor grill and oven appliance is provided. The indoor grill and oven appliance defines a vertical direction and includes a cabinet defining an oven cooking chamber, one or more oven heating elements configured to heat the oven cooking chamber, and one or more grill heating elements. The one or more grill heating elements are disposed within the cabinet and positioned above the oven cooking chamber along the vertical direction. The indoor grill and oven appliance additionally includes one or more grates in thermal communication with the one or more grill heating elements and a hood assembly. The hood assembly is disposed above the one or more grates along the vertical direction and is moveable between an open position and a closed position. The hood assembly defines a substantially enclosed grill cooking chamber with the cabinet when the hood assembly is in the closed position.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front elevation view of an indoor grill and oven appliance in accordance with an exemplary embodiment of the present subject matter.

FIG. 2 provides a first perspective view of the exemplary indoor grill and oven appliance of FIG. 1.

FIG. 3 provides a second perspective view of the exemplary indoor grill and oven appliance of FIG. 1.

FIG. 4 provides a side cross-sectional view of a grilling portion of the exemplary indoor grill and oven appliance of FIG. 1.

FIG. 5 provides a front cross-sectional view of the grilling portion of the exemplary indoor grill and oven appliance of FIG. 1.

FIG. 6 provides a perspective view of an indoor grill and oven appliance in accordance with another exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

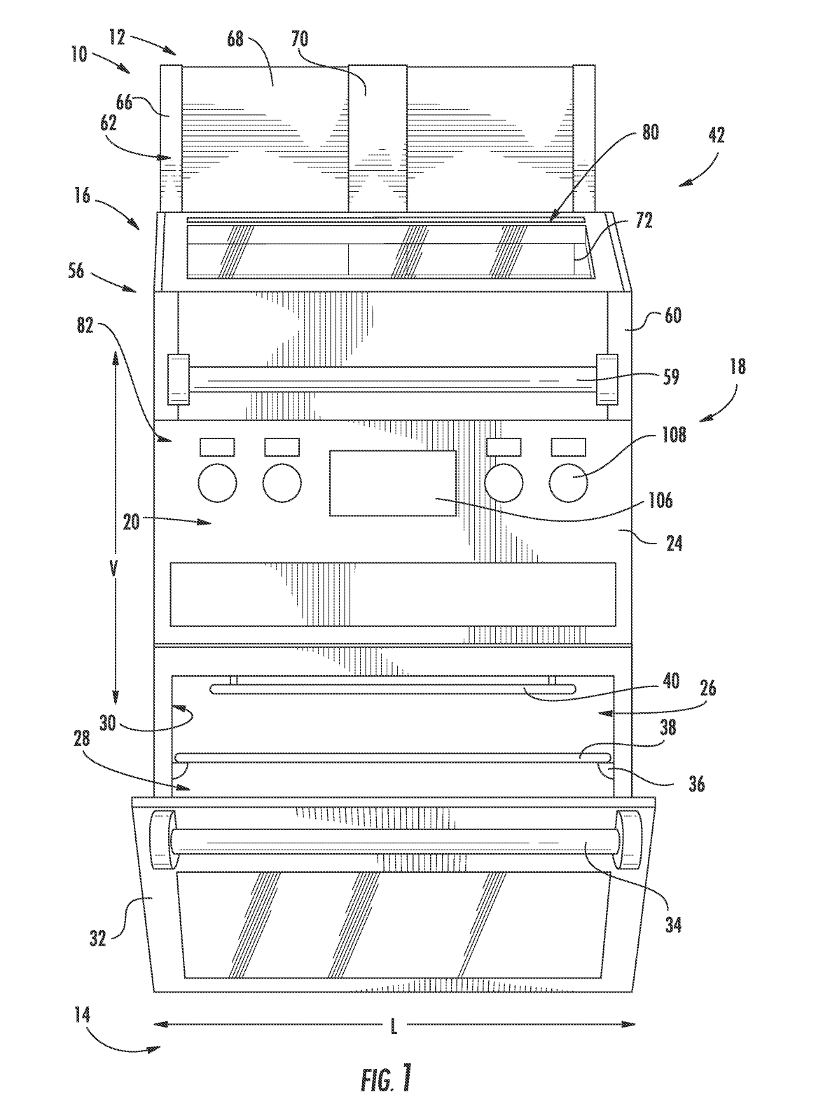

Referring now to the drawings, FIG. 1 provides a front elevation view of an indoor grill and oven range appliance 10 in accordance with an exemplary embodiment of the present subject matter. As will be explained in greater detail below, it should be understood that indoor grill and oven appliance 10 of FIG. 1 is provided by way of example only and is not intended to limit the present subject matter in any aspect.

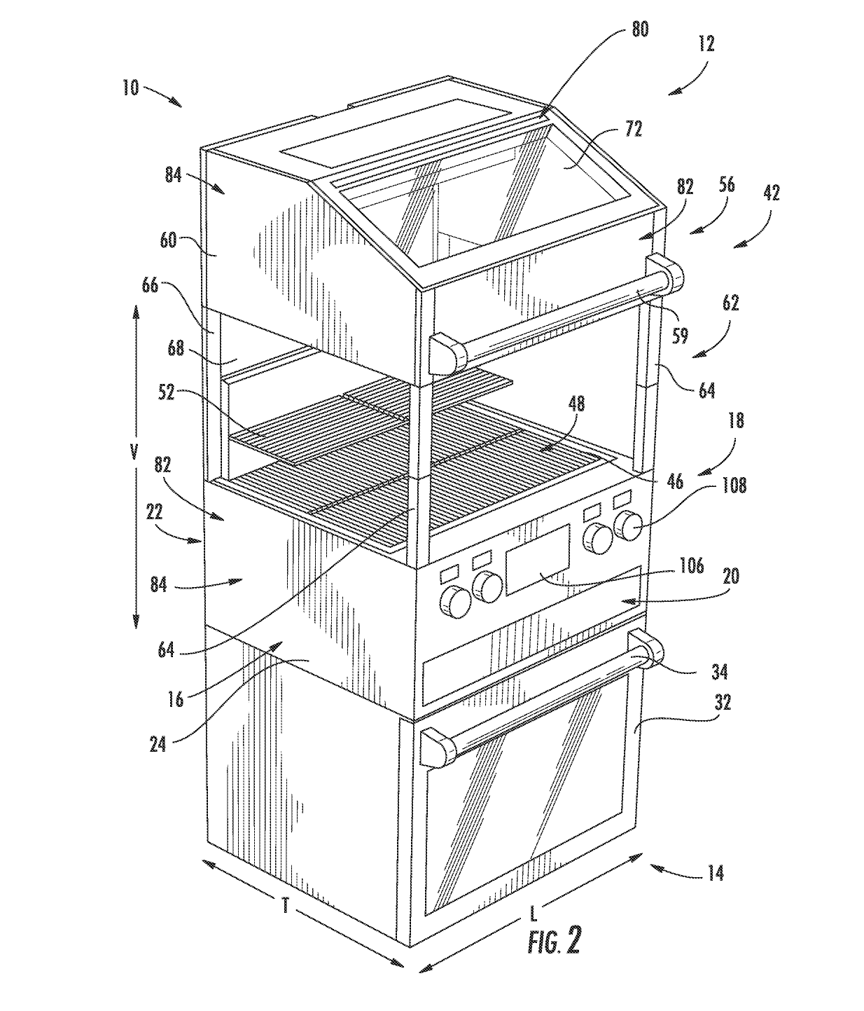

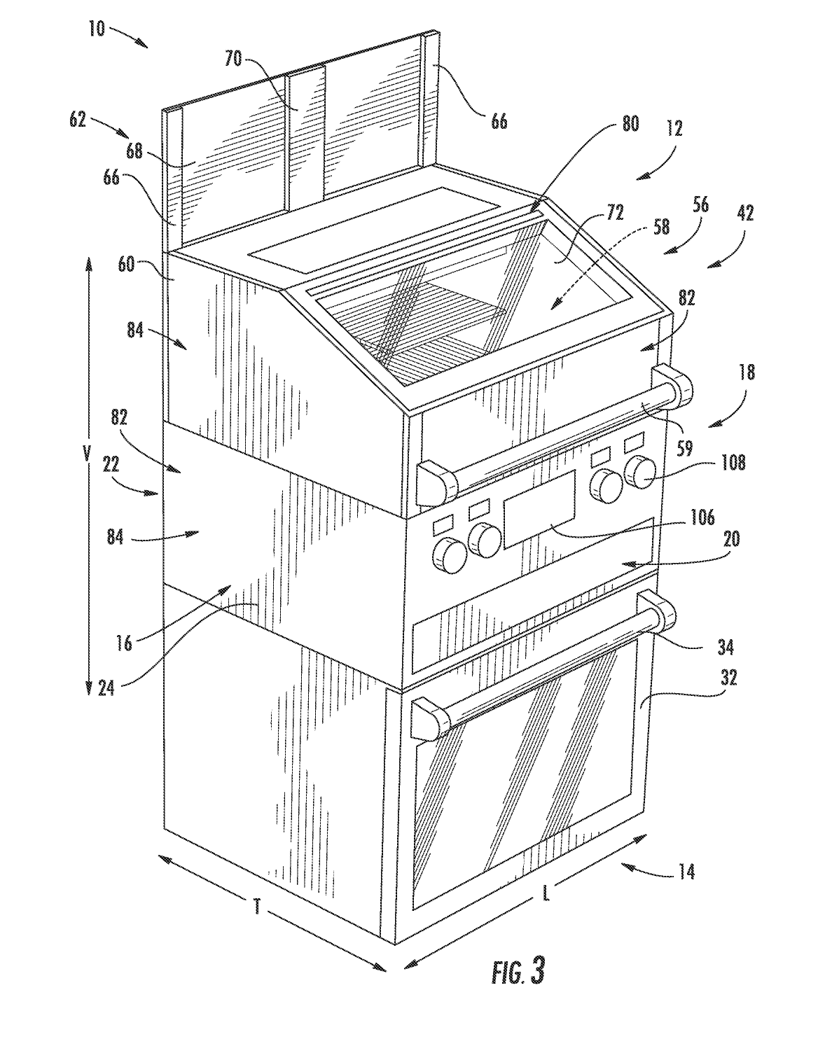

As may be seen in FIG. 1, indoor grill and oven appliance 10 defines a vertical direction V, a lateral direction L, and a transverse direction T (see also FIGS. 2 and 3). The vertical, lateral, and transverse directions V, L, and T are mutually perpendicular and form an orthogonal direction system. Appliance 10 extends between a top portion 12 and a bottom portion 14 along the vertical direction V; between a first side 16 and a second and opposite side 18 along the lateral direction L; and between a front side 20 and a rear side 22 along the transverse direction T (see also FIGS. 2 and 3).

Indoor grill and oven appliance 10 includes a cabinet 24. Cabinet 24 defines an interior oven cooking chamber 26 and an oven cooking chamber opening 28. Oven cooking chamber 26 is defined by an interior surface 30 of cabinet 24 and is configured for receipt of one or more food items to be cooked. Oven cooking chamber opening 28 is positioned at front side 20 of cabinet 24 and permits access to oven cooking chamber 26 of cabinet 24. Indoor grill and oven appliance 10 also includes an oven door 32 rotatably mounted to cabinet 24, e.g., with a hinge (not shown). Oven door 32 is positioned at or adjacent to oven cooking chamber opening 28 of cabinet 24 and is selectively moveable between an open position (FIG. 1) and a closed position (FIGS. 2 and 3). With oven door 32 in the open position, a user can access oven cooking chamber 26 of cabinet 24 through opening 28 of cabinet 24. Conversely, oven door 32 hinders or prevents access to oven cooking chamber 26 of cabinet 24 through opening 28 of cabinet 24 when oven door 34 is in the closed position. An oven handle 34 is mounted to oven door 32 and may assist a user with shifting oven door 32 between the open and closed positions in order to access oven cooking chamber 26. For example, a user can pull on handle 34 to adjust oven door 32 from the closed position to the open position and access oven cooking chamber 28.

Indoor grill and oven appliance 10 additionally includes a plurality of mounting features 36 for receiving one or more oven racks 38 within oven cooking chamber 28. More particularly, the exemplary indoor grill and oven appliance 10 includes embossed ribs or sliding rails such that the one or more oven racks 38 may be conveniently moved into and out of oven cooking chamber 26 when oven door 32 is open. The one or more oven racks 38 may be used to hold or support one or more food items and/or cooking utensils when positioned on the sliding rails within the cooking chamber 26.

One or more oven heating elements are provided to heat the oven cooking chamber 26. For example, a bake or bottom heating element (not shown) may be positioned in cabinet 24, e.g., at a bottom end of oven cooking chamber 26. Bottom heating element may be used to heat oven cooking chamber 26 for both cooking and cleaning of indoor grill and oven appliance 10. The size and heat output of bottom heating element can be selected based on the e.g., the size of indoor grill and oven appliance 10. Bottom heating element can be any suitable heating element. For example, bottom heating element may be an electric resistance heating element, a gas burner, a microwave heating element, etc.

The one or more oven heating elements may also include a broil or top heating element 40 positioned in cooking chamber 26 of cabinet 24, e.g., at a top end of the cooking chamber 28. Top heating element 40 may be used to heat cooking chamber 26 for both cooking/broiling and cleaning of indoor grill and oven appliance 10. Like bottom heating element, the size and heat output of top heating element 40 can be selected based on e.g., the size of indoor grill and oven appliance 10. Top heating element 40 can be any suitable heating element. For example, top heating element 40 may be an electric resistance heating element, a gas burner, a microwave heating element, etc.

Referring now also to FIGS. 2 and 3, perspective views of the exemplary indoor grill and oven appliance 10 of FIG. 1 are provided. More particularly, FIG. 2 provides a perspective view of the exemplary indoor grill and oven appliance 10 with a hood assembly 56 in an open position; and FIG. 3 provides a perspective view of the exemplary indoor grill and oven appliance 10 with the hood assembly 56 in a closed position.

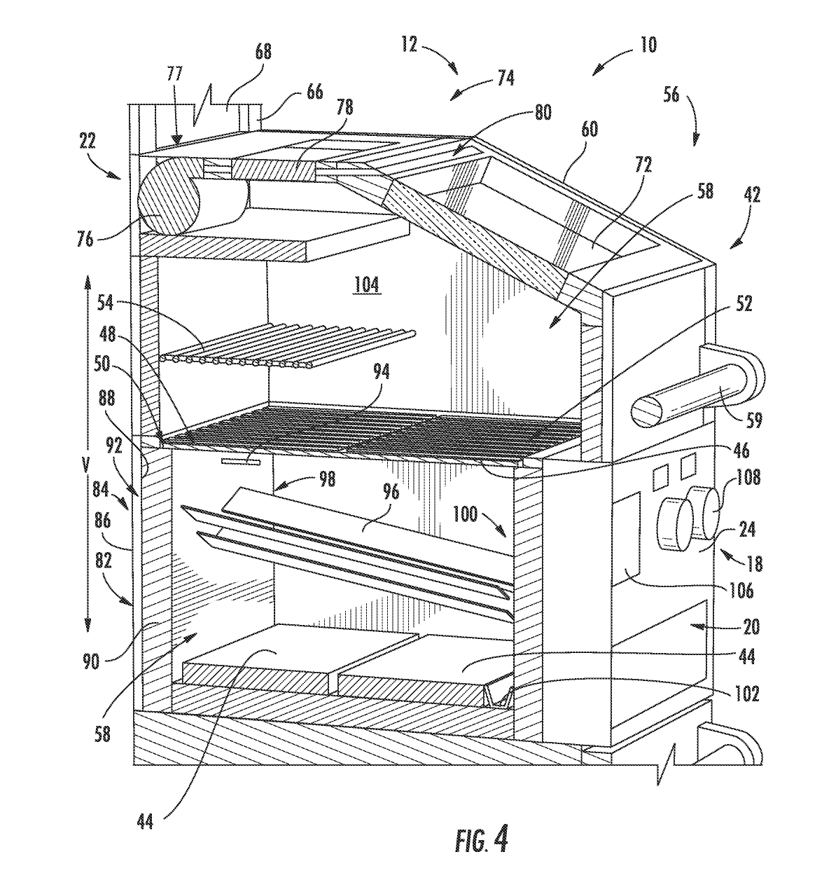

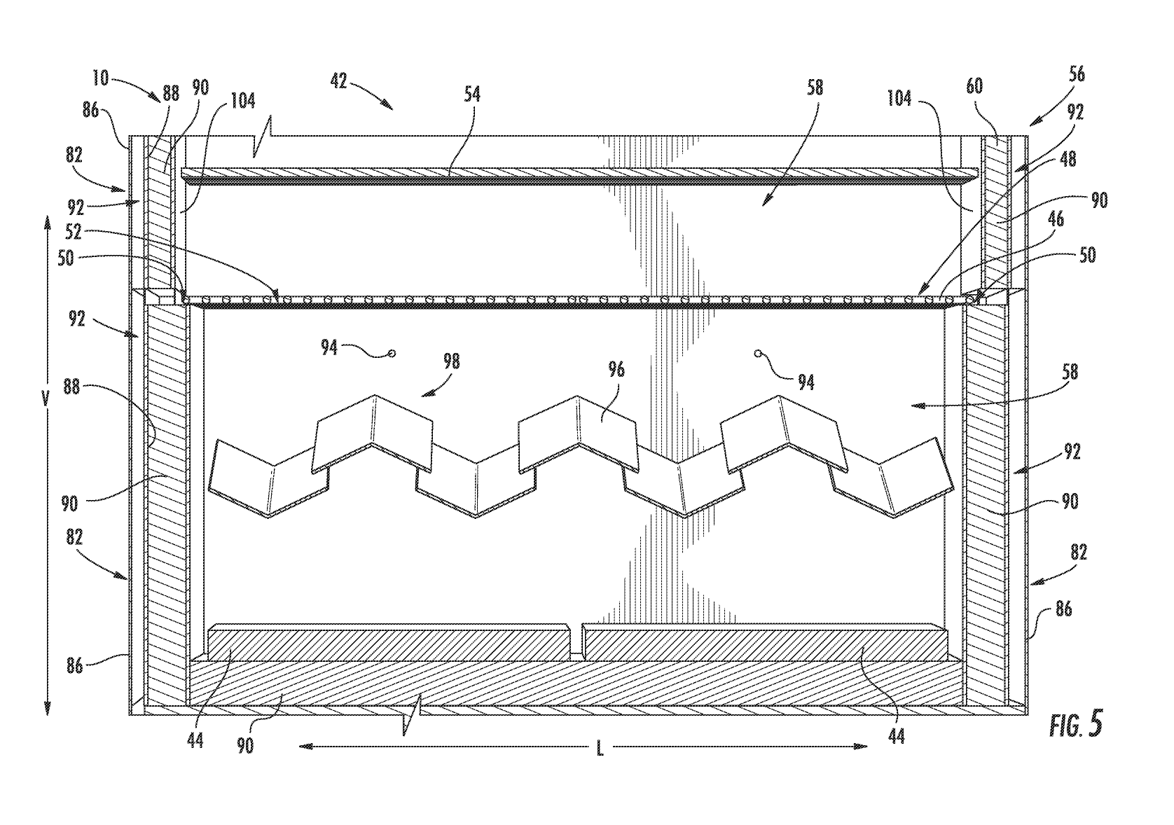

As shown, indoor grill and oven appliance 10 also includes a grill portion 42 positioned generally at the top end 16 of indoor grill and oven appliance 10. As will be discussed in greater detail below with reference to FIGS. 4 and 5, indoor grill and oven appliance 10 includes one or more grill heating elements 44 disposed within the cabinet 24 and positioned above oven cooking chamber 26 along the vertical direction V to provide grill portion 42 a desired amount of heat energy for grilling operations. Additionally, indoor grill and oven appliance 10 includes one or more grates 46 in thermal communication with the one or more grill heating elements 44. For the embodiment depicted, the one or more grates 46 are disposed above the one or more grill heating elements 44 along the vertical direction V and define a planar grilling surface 48 continuously extending over each of the one or more grill heating elements 44. As used herein, the term “planar” refers to extending generally in a plane defined by the lateral and transverse directions L, T.

Additionally, for the embodiment depicted in FIGS. 2 and 3, a single grate 46 is provided defining a substantially rectangular shape and configured to rest on an inner ledge 50 defined by cabinet 24 (see FIGS. 4 and 5). The grate 46 depicted is comprised of a plurality of elongated wire members. However, in other exemplary embodiments, a plurality of grates 46 may be provided having any other suitable configuration. Each of the one or more grates 46 may be configured to directly receive one or more food items in order to grill the one or more food items. Accordingly, each of the one or more grates 46 define a plurality of openings 52, allowing the one or more food items to be cooked using radiant heat from the one or more grill heating elements 44, as well as with conductive heat from the one or more grates 46.

The exemplary indoor grill and oven appliance 10 further includes a secondary shelf 54 positioned above the one or more grates 46 and spaced apart from the one or more grates 46 along the vertical direction V. The secondary shelf 54 may be configured in generally the same manner as the one or more grates 46, e.g., as a plurality of wire members, or in any other suitable manner.

Referring still to FIGS. 2 and 3, and as previously stated, the indoor grill and oven appliance 10 further includes hood assembly 56. For the embodiment depicted, hood assembly 56 is disposed above the one or more grates 46 and may define a substantially enclosed grill cooking chamber 58 with cabinet 24. More particularly, the hood assembly 56 is positioned at top end 12 of appliance 10, adjacent to the one or more grates 46, and movable between an open position (FIG. 2) and a closed position (FIGS. 1 and 3). For the embodiment depicted, the hood assembly 56 moves generally along the vertical direction V between the open position in the closed position. When hood assembly 56 is in the closed position, hood assembly 56 defines the substantially enclosed grill cooking chamber 58 with the cabinet 24. It should be appreciated, that as used herein, the term “substantially enclosed” refers to defining an identifiable space with enclosures on all sides.

As is depicted, hood assembly 56 generally includes a base 60 and a plurality of support members 62. The plurality of support members 62 are configured to support and guide base 60 of hood assembly 56 when hood assembly 56 is, e.g., moved from the closed position to the open position. With hood assembly 56 in the open position, a user can access grill cooking chamber 58. By contrast, however, when hood assembly 56 is in the closed position, grill cooking chamber 58 is substantially enclosed providing a desirable grilling configuration. A grill handle 59 is mounted to hood assembly 56 and may assist a user with moving hood assembly 56 between the open and closed positions in order to access grill cooking chamber 58.

Moreover, one or more of the plurality of support 62 members may be attached to cabinet 24 and base 60 of hood assembly 56, and may extend between cabinet 24 and base 60 of hood assembly 56 when hood assembly 56 is in the open position. For example, in certain exemplary embodiments, one or more of the plurality of support members 62 may be fixed to one of cabinet 24 or base 60 of hood assembly 56, and slidably attached to the other of the cabinet 24 or base 60 of hood assembly 56. Additionally, or alternatively, one or more of the plurality of support members 62 may be fixed to both cabinet 24 and base 60 of hood assembly 56, and may be an extendable support member. As used herein, “fixed” refers to any suitable rigid attachment means, such as welding, bolting, etc.

More particularly, for the embodiment depicted, the plurality of support members 62 include two front support members 64 and two rear support members 66. The front support members 64 are positioned generally at front side 20 of appliance 10 with one front support member 64 proximate to first side 16 and the other front support 64 member proximate to second side 18. The rear support members 66 are positioned generally at rear side 22 of appliance 10 with one rear support member 66 proximate to first side 16 and the other rear support member 66 proximate to second side 18. Accordingly, the plurality of support members 62 are generally positioned at all four corners of hood assembly 56.

Additionally, for the embodiment depicted, the front support members 64 are configured as extendable support members, or more specifically, as telescoping support members. Front support members 64 may be fixed to cabinet 24 and/or to base 60 of hood assembly 56 and extend between cabinet 24 and base 60 of hood assembly 56 when hood assembly 56 is in the open position (see FIG. 2). More particularly, the front support members 64 include two or more components slidably attached to one another and moveable between a retracted position when hood assembly 56 is in the closed position and in an extended position when hood assembly 56 is in the open position. For example, in certain embodiments, the two or more components of the front support members 64 may nest within one another.

By contrast, however, rear support members 66 are configured as slide support members such that base 60 of hood assembly 56 is slidably attached to rear support members 66. For example, base 60 may include a bracket (not shown) that slidably attaches base 62 to rear support members 66 using, e.g., a ball bearings connection. Such a configuration allows base 60 of hood assembly 56 to slide along rear support members 66 when hood assembly 56 moves between the open position and the closed position.

Rear support members 56 are mounted to a backplate 68 of hood assembly 56. The backplate 68 of hood assembly 56 may be attached to or formed integrally with a portion of cabinet 24. Hood assembly 56 also includes a support channel 70 attached to the backplate 68 and spaced evenly between the two rear support members 66 along the lateral direction L. In certain embodiments, one or more of rear support members 66 and support channel 70 may be formed integrally with backplate 68 of hood assembly 56, may be attached to backplate 68 of hood assembly 56 in any suitable manner, or may simply be positioned adjacent to backplate 68. In an alternative exemplary embodiment, however, hood assembly 56 may not include backplate 68.

Support channel 70 may include one or more biasing members (not shown) to assist a user in moving hood assembly 56 between the closed position and the open position. For example, one or more springs may be provided within support channel 70 to offset a weight of base 60 of hood assembly 56. Additionally, or alternatively, a counterweight and pulley may be provided within support channel 70 to offset the weight of base 60 of hood assembly 56. In other exemplary embodiments, however, any other suitable biasing member may be provided, or alternatively, no biasing member may be provided.

Once hood assembly 56 has been moved to the open position, base 60 of hood assembly 56 may be held in position by one or more locking members (not shown), such as by one or more friction locking members. The one or more locking members may be, for example, attached to base 60 and configured to interact with one or more of the plurality of support members 62, such as with one or both of rear support members 66. In certain exemplary embodiments, the locking members may be manually activated, such that a user must engage the one or more locking members when base 60 of hood assembly 56 is in a desired position to maintain base 60 of hood assembly 56 in the desired position. Alternatively, the locking members may be automatically activated when base 60 of hood assembly 56 is moved to, e.g., the open position. Alternatively still, the locking members may be biased towards an engaged position, such that a user must manually disengage the locking members to move base 60 of hood assembly 56 from a given position.

Hood assembly 56 additionally includes a transparent panel 72 allowing a user to view into the grill cooking chamber 58 when hood assembly 56 is in the closed position. In certain embodiments, transparent panel 72 may include dual panes of reflective-coated glass, such as, e.g., a tin oxide coating, separated by a layer of cooling airflow. For example, the cooling airflow may be driven by natural convection, or alternatively a cooling fan (not shown) may be provided.

Referring now to FIGS. 4 and 5, cross-sectional views of grilling portion 42 of indoor grill and oven appliance 10 are provided. Specifically, FIG. 4 provides a cross-sectional view taken generally along the lateral direction L and FIG. 5 provides a close-up, cross-sectional view taken along the transverse direction T. As shown, hood assembly 56 of indoor grill and oven appliance 10 includes an exhaust system 74. Exhaust system 74 is configured to assist hood assembly 56 in capturing cooking gases generated in grill cooking chamber 58 during grilling operations (i.e., during operation of the one or more grill heating elements 44). For the embodiment depicted, exhaust system 74 includes a fan 76, a condenser 78, and an exhaust outlet 80. As depicted, fan 76 is positioned within base 60 of hood assembly 56 and in flow communication with grill cooking chamber 58; condenser 78 is positioned in flow communication with fan 76, downstream of fan 76; and exhaust outlet 80 is positioned in flow communication with condenser 78, downstream of condenser 78.

During operation of fan 76, fan 76 urges a flow of air from grill cooking chamber 58 through exhaust outlet 80. More particularly, fan 76 urges the flow of air from grill cooking chamber 58, including any cooking gasses generated in grill cooking chamber 58, through condenser 78 and out exhaust outlet 80. In certain exemplary embodiments, fan 76 may be configured to increase in speed when hood assembly 56 moved from the closed position to the open position. For example, fan 76 may increase its speed by at least about 25%, by at least about 50%, by at least about 75%, by at least about 100%, or by at least about 150%. Such an embodiment may assist in capturing substantially all of the unconditioned grill cooking gases generated in grill cooking chamber 58 during grilling operations, regardless of whether hood assembly 56 is in the open position or the closed position. For example, in certain exemplary embodiments, indoor grill and oven appliance 10 may include one or more sensors (not shown) to determine the location of base 60 of hood assembly 56. The sensors and fan 76 may be in operable communication with a controller (discussed below) to provide such functionality.

Moreover, condenser 78 is configured to condition the flow of air from grill cooking chamber 58. More particularly, condenser 78 is configured to cool the flow of air from grill cooking chamber 58 and condense any grease or other contaminants contained in the flow of air from grill cooking chamber 58. Accordingly, condenser 78 may essentially act as both a heat exchanger and a filter for the flow of air from grill cooking chamber 58. In certain embodiments, the condenser 78 may be removable to allow a user to, e.g., clean or replace condenser 78 as needed. Further, exhaust outlet 80 is configured to exhaust the conditioned air to a room in which the indoor grill and oven appliance 10 is positioned. Therefore, indoor grill and oven appliance 10 including exemplary exhaust system 74 may allow for a user to conduct grilling operations indoors with a reduced risk of, e.g., damaging a ceiling of a room in which the indoor grill and oven appliance 10 is positioned.

It should also be appreciated, that for the embodiment depicted, hood assembly 56 defines a gap 77 such that relatively cool ambient air mixes with the grill cooking gases in fan 76. The relatively cool ambient air may assist condenser 78 in cooling the cooking gases. Moreover, by introducing the relatively cool ambient air to fan 76, the relatively cool ambient air may assist in cooling fan 76 during operation. In alternative embodiments, gap 77 may additionally, or alternatively, be defined at any suitable location in hood assembly 56 or elsewhere to introduce relatively cool ambient air to fan 76 and/or condenser 78.

Indoor grill and oven appliance 10 is further configured to maintain a temperature of an outside surface 82 of cabinet 24 and hood assembly 56 below a certain temperature threshold, regardless of any grilling operations. For example, indoor grill and oven appliance 10 may be configured to maintain the temperature of outside surface 82 below a temperature which may cause harm if touched by a user. Accordingly, referring still to FIGS. 4 and 5, at least a portion of cabinet 24 and base 60 of hood assembly 56 are constructed in a “double wall” configuration. For example, one or both of cabinet 24 and hood assembly 56 include one or more sidewalls 84 adjacent to grill cooking chamber 58 having such a configuration. More particularly, both exemplary cabinet 24 and hood assembly 56 are depicted including four sidewalls 84 having such a construction—a sidewall 84 at front side 20, a sidewall 84 at rear side 22, a sidewall 84 at first side 16, and a sidewall 84 at second side 18—surrounding at least a portion of grill cooking chamber 58. Each sidewall 84 generally includes an outer panel 86, an inner panel 88, and an insulation layer 90. Inner panel 88 is disposed between outer panel 86 and insulation layer 90, and is spaced from outer panel 86 to define an air chamber 92 therebetween. In certain embodiments, indoor grill and oven appliance 10 may be configured to allow for a flow of air through air chamber 92 during grilling operations to further reduce a temperature of outer panel 86, or more particularly to further reduce a temperature of outer surface 82 of cabinet 24 and/or hood assembly 56. Such an airflow may be provided by, e.g., natural convection, or alternatively by including a fan in flow communication with air chamber 92 (not shown).

Moreover, in certain embodiments, outer panel 86 may be comprised of a material that defines a high coefficient of heat transfer to help reduce the temperature of outside surface 82, while inner panel 88 may be comprised of a material selected that exhibits high strength and corrosion resistance properties to increase a durability of appliance 10. For example, in certain exemplary embodiments, outer panel 86 may be comprised of an aluminum material, while inner panel 88 may be comprised of a steel material.

As previously stated, indoor grill and oven appliance 10 also includes one or more grill heating elements 44 disposed within cabinet 24 and positioned above oven cooking chamber 28 along the vertical direction V. For the embodiment depicted, the one or more grill heating elements 44 are electric resistance heaters positioned below the one or more grates 46 along the vertical direction V. Moreover, for the embodiment depicted, the one or more grill heating elements 44 include at least four electric resistance heaters (see also FIG. 5). More particularly, exemplary indoor grill and oven appliance 10 includes a pair of front grill heating elements 44 positioned closer to front side 20 of appliance 10 and a pair of rear grill heating elements 44 positioned closer to rear side 22 of appliance 10. One of the pair of front grill heating elements 44 is positioned closer to first side 16 of appliance 10 and the other of the pair of front grill heating elements 44 is positioned closer to second side 18 of appliance 10. Similarly, one of the pair of rear grill heating elements 44 is positioned closer to first side appliance 10 and the other of the pair of rear grill heating elements 44 is positioned closer to second side 18 of appliance 10. Each grill heating element 44 defines a separate grilling zone within the grill cooking chamber 58 and may be controlled independently by a user, e.g., in the manner discussed below, to vary a temperature of the respective grilling zone.

The indoor grill and oven appliance 10 further includes a plurality of temperature sensors 94 positioned within or adjacent to grill cooking chamber 58. Each of the plurality of temperature sensors 94 may be positioned to measure a temperature of the different grilling zones defined within grill cooking chamber 58.

It should be appreciated, however, that in other exemplary embodiments, the indoor grill and oven appliance 10 may include any suitable number of grill heating elements 44, grilling zones, and/or temperature sensors 94. For example, in certain exemplary embodiments, appliance 10 may include at least two grill heating elements 44 and/or sensors 94, may include at least three grill heating elements 44 and/or sensors 94, or may include at least five grill heating elements 44 and/or sensors 94. Moreover, in still other exemplary embodiments, the one or more grill heating elements 44 for indoor grill and oven appliance 10 may additionally, or alternatively, include any other suitable form of heating element. For example, in other exemplary embodiments, the one or more grill heating elements 44 may additionally, or alternatively include infrared heating elements.

Referring still to FIGS. 4 and 5, the exemplary indoor grill and oven appliance 10 further includes shields 96 disposed within the cabinet 24 and positioned in the grill heating chamber between the one or more grill heating elements 44 and the one or more grates 46. Shields 96 cover each of the one or more grill heating elements 44 and may protect the grill heating elements 44 from, e.g., fluids and/or particles of food. Such a configuration may prevent, e.g., generating undesired smoke during grilling operations. For the embodiment depicted, for example, indoor grill and oven appliance 10 defines a horizontal plane (i.e., a plane defined by the transverse direction T and the lateral direction L), and the one or more shields 96 define an angle relative to the horizontal plane. Accordingly, the one or more shields 96 each define a high-end 98 (closer to rear end 22 of appliance 10) and a low-end 100 (closer to front end 20 of appliance 10). Moreover, the exemplary appliance 10 depicted further includes a drip tray 102 positioned within the grill cooking chamber 58. Low-end 100 of the one or more shields 96 is positioned directly above the drip tray 102, such that shields 96 redirect fluid that drops onto shields 96 from the one or more grates 46 into the drip tray 102. For the embodiment depicted, each of the one or more shields 96 extends generally along the lateral direction L and the drip tray 102 extends generally along the transverse direction T. However, in other embodiments, any other configuration may be provided such that shields 96 redirect dripped liquids to the drip tray 102. Further, in certain embodiments, the drip tray 102 may be removable to allow a user to, e.g., clean and/or replace drip tray 102 as needed. Notably, shields 96 may additionally assist with more evenly distributing heat from the one or more grill heating elements 44.

Referring still to FIGS. 4 and 5, the indoor grill and oven appliance 10 further includes one or more removable splash panels 104 positioned within the grill cooking chamber 58 adjacent to cabinet 24 and/or hood assembly 56. The one or more splash panels may be removably attached to cabinet 24 or hood assembly 56 in any suitable manner. The one or more removable splash panels 104 are configured to protect cabinet 24 from grease and/or other contaminants during grilling operations of indoor grill and oven appliance 10. For example, in the embodiment depicted hood assembly 56 includes a removable splash panel 104 within grill cooking chamber 58 at first side 16 of appliance 10 and a removable splash panel 104 within grill cooking chamber 58 at second side 18 of appliance 10. Similarly, cabinet 24 includes a removable splash panel 104 within grill cooking chamber 58 at first side 16 of appliance 10 and a removable splash panel 104 within grill cooking chamber 58 at second side 18 appliance 10. A user may remove one or all of the removable splash panels 104 to assist with cleaning the indoor grill and oven appliance 10.

The operation of indoor grill and oven appliance 10, including the one or more oven heating elements and one or more grill heating elements 44, is controlled by one or more processing devices (not shown) such as a microprocessor or other device that is in operable communication with such components. Such processing device (used herein to refer generally to single and/or multiple processing devices) may also be in operable communication with other components of appliance 10, such as fan 76 of exhaust system 74 in hood assembly 56 and the one or more temperature sensors 94 positioned in or adjacent to grill cooking chamber 58. Further, such processing device may be in operable communication with a control panel 106 having a plurality of user inputs 108 and, e.g., additional temperature sensors (not shown) that are used to measure a temperature inside oven cooking chamber 28. Control panel 106 provides visual information to a user and allows a user to select various options for the operation of indoor grill and oven appliance 10 via user inputs 56. For example, control panel 106 may display a temperature of each grilling zone within grill cooking chamber 58. One or more of a variety of electrical, mechanical or electro-mechanical input devices including rotary dials, push buttons, toggle/rocker switches, and/or touch pads can also be used singularly or in combination as user inputs 108.

An indoor grill and oven appliance 10 in accordance with the present disclosure may allow for indoor grilling of one or more food items without having unfiltered or unconditioned cooking gases expel into a room in which the appliance 10 is positioned (minimizing a risk of damaging and/or dirtying walls and a ceiling of such room). Moreover, an indoor grill and oven appliance 10 in accordance with the present disclosure may allow for operation of appliance 10, or more particularly, may allow for conducting of grilling operations, while maintaining a temperature of outer surface 82 of cabinet 24 and/or hood assembly 56 below a desired temperature threshold.

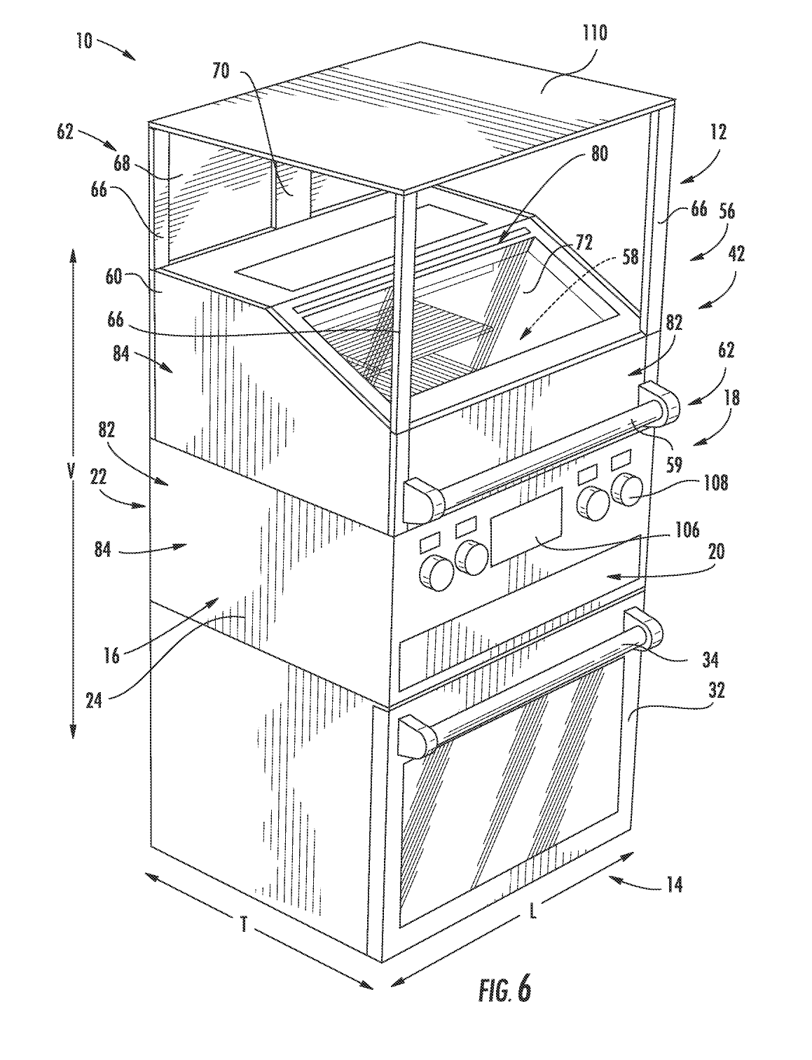

Referring now to FIG. 6, a perspective view of an indoor grill and oven appliance 10 in accordance with another exemplary embodiment of the present subject matter is provided. The exemplary indoor grill and oven appliance 10 depicted in FIG. 6 may be configured in substantially the same manner as the exemplary indoor grill and oven appliance 10 described above with reference to FIGS. 1 through 5. However, for the embodiment of FIG. 6, hood assembly 56 further includes a top plate member 110. Top plate member 110 is attached to backplate 68 at rear 22 of appliance 10 and is attached to front support members 64 at front 20 of appliance 10. Front support members 64 may be configured in substantially the same manner as in the embodiment discussed above, except front support members 64 depicted in the exemplary embodiment of FIG. 6 may be attached to top plate member 110 instead of cabinet 24. Accordingly, front support members 64 may be extendable support members. Alternatively, however, in other embodiments, front support members 64 may be rigidly attached to top plate 110 member as well as to cabinet 24. In such an exemplary embodiment, front support members 64 may be slidable support members, such that the base 60 of hood assembly 56 is slidably attached to front support members 64.

It should be appreciated, however, that in other exemplary embodiments, indoor grill and oven appliance 10, including hood assembly 56, may have any other suitable configuration. For example, in other embodiments, hood assembly 56 may include any additional or alternative structure for assisting, supporting, and/or guiding hood assembly 56 into or between the closed position and the open position. Furthermore, although appliance 10 is depicted including an oven cooking chamber 28, in other exemplary embodiments, appliance 10 may not include oven cooking chamber 28. Accordingly, in certain exemplary embodiments, appliance 10 may not be an indoor grill and oven appliance 10, and instead may simply be an indoor grill appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An indoor grill and oven appliance defining a vertical direction, the appliance comprising:
a cabinet defining an oven cooking chamber;
one or more oven heating elements configured to heat the oven cooking chamber;
one or more grill heating elements disposed within the cabinet and positioned above the oven cooking chamber along the vertical direction;
one or more grates in thermal communication with the one or more grill heating elements; and
a hood assembly disposed above the one or more grates along the vertical direction, the hood assembly defining a substantially enclosed grill cooking chamber with the cabinet.

2. The indoor grill and oven appliance of claim 1, wherein the one or more grill heating elements are electric resistance heaters.

3. The indoor grill and oven appliance of claim 1, wherein the cabinet includes one or more sidewalls adjacent to the grill cooking chamber, the one or more sidewalls comprising an outer panel and an insulation layer.

4. The indoor grill and oven appliance of claim 3, wherein the one or more sidewalls further comprise an inner panel, wherein the inner panel is disposed between the outer panel and the insulation layer, and wherein the inner panel is spaced from the outer panel to define an air chamber therebetween.

5. The indoor grill and oven appliance of claim 4, wherein the indoor grill and oven appliance is configured to allow for a flow of air through the air chamber during grilling operations to reduce a temperature of the outer panel.

6. The indoor grill and oven appliance of claim 4, wherein the outer panel is comprised of aluminum, and wherein the inner panel is comprised of steel.

7. The indoor grill and oven appliance of claim 1, further comprising
one or more shields disposed within the cabinet above the one or more grill heating elements and below the one or more grates.

8. The indoor grill and oven appliance of claim 7, wherein the indoor grill and oven appliance further defines a horizontal plane, and wherein the one or more shields define an angle relative to the horizontal plane.

9. The indoor grill and oven appliance of claim 8, further comprising
a tray disposed within the cabinet, wherein the one or more shields each define a low end and a high end, and wherein the low end of the one or more shields is disposed directly above the tray to redirect fluids that drop onto the shields from the one or more grates into the tray.

10. The indoor grill and oven appliance of claim 1, further comprising
one or more removable splash panels positioned within the grill cooking chamber adjacent to one or both of the cabinet in the lid assembly, the one or more removable splash panels configured to protect one or both of the cabinet and the hood assembly from grease or other contaminates during grilling operations.

11. The indoor grill and oven appliance of claim 1, further comprising
a plurality of temperature sensors positioned within the grill cooking chamber, wherein the grill cooking chamber defines a plurality of grilling zones, and wherein each of the plurality of temperature sensors is configured to measure a temperature of a different zone.

12. The indoor grill and oven appliance of claim 1, wherein the one or more grates define a planar grilling surface.

13. An indoor grill and oven appliance defining a vertical direction, the appliance comprising:
a cabinet defining an oven cooking chamber;
one or more oven heating elements configured to heat the oven cooking chamber;
one or more grill heating elements disposed within the cabinet and positioned above the oven cooking chamber along the vertical direction;
one or more grates in thermal communication with the one or more grill heating elements; and
a hood assembly disposed above the one or more grates along the vertical direction and moveable between an open position and a closed position, the hood assembly defining a substantially enclosed grill cooking chamber with the cabinet when the hood assembly is in the closed position.

14. The indoor grill and oven appliance of claim 13, wherein the cabinet includes one or more sidewalls adjacent to the grill cooking chamber, the one or more sidewalls comprising an outer panel and an insulation layer.

15. The indoor grill and oven appliance of claim 14, wherein the one or more sidewalls further comprise an inner panel, wherein the inner panel is disposed between the outer panel and the insulation layer, and wherein the inner panel is spaced from the outer panel to define an air chamber therebetween.

16. The indoor grill and oven appliance of claim 15, wherein the indoor grill and oven appliance is configured to allow for a flow of air through the air chamber during grilling operations to reduce a temperature of the outer panel.

17. The indoor grill and oven appliance of claim 1, further comprising
one or more shields disposed within the cabinet above the one or more grill heating elements and below the one or more grates.

18. The indoor grill and oven appliance of claim 1, further comprising
one or more removable splash panels positioned within the grill cooking chamber adjacent to one or both of the cabinet in the lid assembly, the one or more removable splash panels configured to protect one or both of the cabinet and the hood assembly from grease or other contaminates during grilling operations.

19. The indoor grill and oven appliance of claim 1, wherein the one or more grates define a planar grilling surface.

20. An indoor grill appliance comprising:
a cabinet;
one or more grill heating elements disposed within the cabinet;
one or more grates in thermal communication with the one or more grill heating elements, the one or more grates defining a planar grilling surface; and
a hood assembly moveable between an open position and a closed position, the hood assembly defining a substantially enclosed grill cooking chamber with the cabinet when in the closed position.
